(19) United States
(12) Patent Application Publication
(10) Pub. No.: US 2026/0089564 A1
(43) Pub. Date: Mar. 26, 2026

(54) USER EQUIPMENT OFFLOADING DURING CUUP AUTO SCALE DOWN

(71) Applicant: Rakuten Symphony, Inc., Tokyo (JP)

(72) Inventors: Kartik Reddy GAYAM, Karnataka (IN); Hanumantappa KORACHARA MAREPPA, Karnataka (IN); Santhiyaku Jeevakumar ANTONYRAJ, Karnataka (IN)

(73) Assignee: Rakuten Symphony, Inc., Tokyo (JP)

(21) Appl. No.: 19/093,463

(22) Filed: Mar. 28, 2025

(30) Foreign Application Priority Data
Sep. 26, 2024 (IN) 202411072880

(51) Int. Cl. H04W 28/08; H04W 24/08; H04W 28/02

(52) U.S. Cl. CPC H04W 28/0835; H04W 24/08; H04W 28/0268; H04W 28/0284

(57) ABSTRACT

A method includes receiving, at an Open Radio Access Network (Open RAN) RAN Intelligent Controller (RIC) 104, a plurality of RIC indication messages from a plurality of gNodeBs (gNBs) 100. Each of the plurality of RIC indication messages comprises one or more network parameters. The method further includes determining whether a plurality network conditions satisfy one or more predefined criteria based on the one or more network parameters. The plurality network conditions comprise an identification of a scale-in, an expiration of a session drain timer, and an absence of any scale-out. The method further includes transmitting a RIC control request in response to the plurality network conditions that satisfy one or more predefined criteria. The RIC control request is transmitted to initiate a change of Centralized Unit User Plane (CU-UP) procedure for a set of User Equipments (UEs) associated with at least one gNB among the plurality of gNBs 100.

### CROSS REFERENCE TO RELATED APPLICATION(S)

This application claims priority based on India patent application No. 202411072880 filed Sep. 26, 2024, the entire disclosure of which is incorporated by reference herein.

### FIELD

The present disclosure relates to User Equipment (UE) offloading during Centralized Unit User Plane (CU-UP) auto scale down.

### BACKGROUND

The information disclosed in this background section is only for enhancement of understanding of the general background of the disclosure and should not be taken as an acknowledgement or any form of suggestion that this information forms the prior art already known to a person skilled in the art.

Currently, a Next Generation Node B (gNB) Centralized Unit User Plane (CU-UP) is instantiated with a predetermined number of instances for one or more scalable micro services (e.g., nrUserPlane), which manage one or more User Equipment (UE) contexts in the UP. As a number of users in the gNB increases or decreases, the CU-UP can be dynamically scale-out or scale-in, optimizing resource utilization.

The scale-in (scale down) of the CU-UP involves reducing resources when they are no longer necessary. The scale-in process for the CU-UP instance encompasses several operations related to a low watermark threshold, a monitoring timer, an auto drain timer, and one or more release procedures. Herein, the low watermark threshold is a predefined limit that signals when the resource utilization or load on the CU-UP instance falls below a specified threshold, potentially due to decreased user activity or a reduction in active sessions. Upon reaching this specified threshold, the gNB activates the monitoring timer to track a duration of underutilization. This monitoring timer ensures that a decision to scale-in is based on sustained low usage rather than transient fluctuations. If the monitoring timer expires without a significant increase in load, the CU-UP instance is flagged for the scale-in, indicating that resource reduction is feasible.

Subsequent to marking the CU-UP instance for the scale-in, the gNB initiates the auto drain timer, which is essential for managing one or more active UE sessions. This auto-drain timer facilitates the orderly termination or migration of the one or more active UE sessions before the CU-UP instance is fully decommissioned. Once the auto drain timer elapses, the gNB assesses any remaining UE sessions linked to the CU-UP instance. If the one or more active UE sessions persist, the gNB may execute a procedure to release these sessions, typically employing one of two methods:
a. RESET procedure: This controlled procedure involves the gNB sending a reset message to the UE(s), notifying it of the impending session termination. The UE(s) can then respond accordingly, ensuring that ongoing data transfers are managed appropriately.
b. Abrupt UE release procedure: This controlled procedure involves immediate resource reclamation; an abrupt release procedure may be enacted. This controlled procedure forcibly disconnects the UE(s) without a graceful termination, potentially resulting in data loss or service interruption for a user(s) of the UE(s).

### SUMMARY

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

According to one embodiment of the present disclosure, a method is disclosed. The method includes receiving, at an Open Radio Access Network (Open RAN) RAN Intelligent Controller (RIC), a plurality of RIC indication messages from a plurality of gNodeBs (gNBs). Each of the plurality of RIC indication messages comprises one or more network parameters. The method further includes determining whether a plurality network conditions satisfy one or more predefined criteria based on the one or more network parameters. The plurality network conditions comprise an identification of a scale-in, an expiration of a session drain timer, and an absence of any scale-out. The method further includes transmitting an RIC control request in response to the plurality network conditions that satisfy one or more predefined criteria. The RIC control request is transmitted to initiate a change of Centralized Unit User Plane (CU-UP) procedure for a set of User Equipments (UEs) associated with at least one gNB among the plurality of gNBs.

According to one embodiment of the present disclosure, a method is disclosed. The method includes receiving, at a Centralized Unit Control Plane (CU-CP) associated with at least one gNodeB (gNB) from a plurality of gNodeBs (gNBs), a RAN Intelligent Controller (RIC) control request. The RIC control request comprises an instruction to transfer context information associated with the set of UEs from a source gNB-CU-UP to a target gNB-CU-UP. The method further includes initiating a change of Centralized Unit User Plane (CU-UP) procedure upon receiving the RIC control request. The change of CU-UP procedure is initiated for a set of User Equipments (UEs) associated with the at least one gNB by utilizing at least one of an Access and Mobility Management Function (AMF) and a User Plane Function (UPF) via performing one or more procedures. The one or more procedures comprise at least one of a bearer context setup procedure, an F1 UE context management procedure, a bearer context modification procedure with the source gNB-CU-UP, a bearer context modification procedure with the target gNB-CU-UP, a context transformation, a path update procedure, and a bearer context release procedure.

According to one embodiment of the present disclosure, an apparatus is disclosed. The apparatus is configured to receive at an Open Radio Access Network (Open RAN) RAN Intelligent Controller (RIC), a plurality of RIC indication messages from a plurality of gNodeBs (gNBs). Each of the plurality of RIC indication messages comprises one or more network parameters. The apparatus is further configured to determine whether a plurality network conditions satisfy one or more predefined criteria based on the one or more network parameters. The plurality network conditions comprise an identification of a scale-in, an expiration of a session drain timer, and an absence of any scale-out. The apparatus is further configured to transmit an RIC control request in response to the plurality network conditions that satisfy one or more predefined criteria. The RIC control request is transmitted to initiate a change of Centralized Unit User Plane (CU-UP) procedure for a set of User Equipments (UEs) associated with at least one gNB among the plurality of gNBs.

According to one embodiment of the present disclosure, a non-transitory computer-readable medium storing instructions, the instructions comprising: one or more instructions that, when executed by an apparatus, the apparatus comprising one or more processors. The one or more processors are configured to receive at an Open Radio Access Network (Open RAN) RAN Intelligent Controller (RIC), a plurality of RIC indication messages from a plurality of gNodeBs (gNBs). Each of the plurality of RIC indication messages comprises one or more network parameters. The one or more processors are further configured to determine whether a plurality network conditions satisfy one or more predefined criteria based on the one or more network parameters. The plurality network conditions comprise an identification of a scale-in, an expiration of a session drain timer, and an absence of any scale-out. The one or more processors are further configured to transmit a RIC control request in response to the plurality network conditions that satisfy one or more predefined criteria. The RIC control request is transmitted to initiate a change of Centralized Unit User Plane (CU-UP) procedure for a set of User Equipments (UEs) associated with at least one gNB among the plurality of gNBs.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a system block diagram for initiating a change of Centralized Unit User Plane (CU-UP) procedure, according to an embodiment as disclosed herein;

FIGS. 2A-2D is a sequence flow diagram illustrating a plurality of operations associated with a plurality of network elements for User Equipment (UE) offloading during CU-UP auto scale down, according to an embodiment as disclosed herein;

FIG. 3 is a sequence flow diagram illustrating a plurality of operations for initiating the change of CU-UP procedure, according to an embodiment as disclosed herein;

FIG. 4 is a flow diagram illustrating a method for transmitting a RAN Intelligent Controller (RIC) control request to initiate the change of CU-UP procedure, according to an embodiment as disclosed herein;

FIG. 5 is a flow diagram illustrating a method for initiating the change of CU-UP procedure by utilizing an Access and Mobility Management Function (AMF) and/or a User Plane Function (UPF), according to an embodiment as disclosed herein; and

FIG. 6 illustrates a diagram of example components of an apparatus, according to an embodiment as disclosed herein.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The foregoing disclosure provides illustration and description but is not intended to be exhaustive or to limit the implementations to the precise form disclosed. Modifications and variations are possible in light of the above disclosure or may be acquired from practice of the implementations.

In the existing mechanisms/procedures, a Centralized Unit User Plane (CU-UP) can dynamically scale-out or scale-in resources as a number of users in a Next Generation Node B (gNB) increases or decreases, aiming to optimize resource utilization. However, several problems are encountered in the existing mechanisms/procedures, which are mentioned below.

Firstly, an abrupt release of one or more active User Equipment (UE) sessions can lead to significant service interruptions for the users. For instance, if a user is streaming a video and the gNB initiates an abrupt UE release, the video stream may suddenly terminate, resulting in a poor user experience. This disruption can lead to dissatisfaction and potential loss of users/customers, especially in services where continuous connectivity is critical, such as video conferencing or online gaming. In addition, the abrupt release procedure can result in data loss for the users, particularly if ongoing data transfers are not properly managed. For example, if a user is uploading a large file and the network initiates an abrupt UE release, the file transfer may be interrupted, causing data corruption or loss. This scenario is particularly critical in applications that require data integrity, such as financial transactions or cloud storage services. Users may lose trust in the network's reliability, leading to decreased customer retention and potential legal ramifications for service providers.

Secondly, when a CU UP instance is marked for the scale-in during the session drain period (auto drain timer), new sessions may still be initiated. For instance, if a network operator decides to the scale-in the CU UP instance due to low usage, but new users log in, the existing mechanisms may trigger the scale-out to accommodate these new sessions. This creates a ping-pong effect where the existing mechanisms oscillate between the scale-in and the scale-out, leading to instability in resource allocation. This not only complicates resource management but can also result in unnecessary overhead, as resources are frequently reallocated without a net gain in efficiency. In addition, a frequent scale-in and scale-out can lead to inefficient resource utilization. For instance, if the CU UP instance scales in but then quickly scales out again due to a surge in new sessions, the resources allocated during the scale-out may not be fully utilized, leading to wasted capacity. This inefficiency can increase operational costs and reduce the overall effectiveness of the network infrastructure, as resources are not being used optimally based on actual demand.

Finally, the constant adjustments in scale-in introduce latency in session handling. For instance, if a user experiences a delay while their session is being re-established after the scale-in, this can affect the performance of time-sensitive applications, such as VOIP calls or online gaming. Increased latency can lead to a degraded user experience, as users may perceive the network as slow or unresponsive, thereby impacting service quality.

Thus, it is desired to address the above-mentioned disadvantages or other shortcomings or at least provide a useful alternative for UE offloading during the CU-UP auto scale down, as discussed throughout the disclosure.

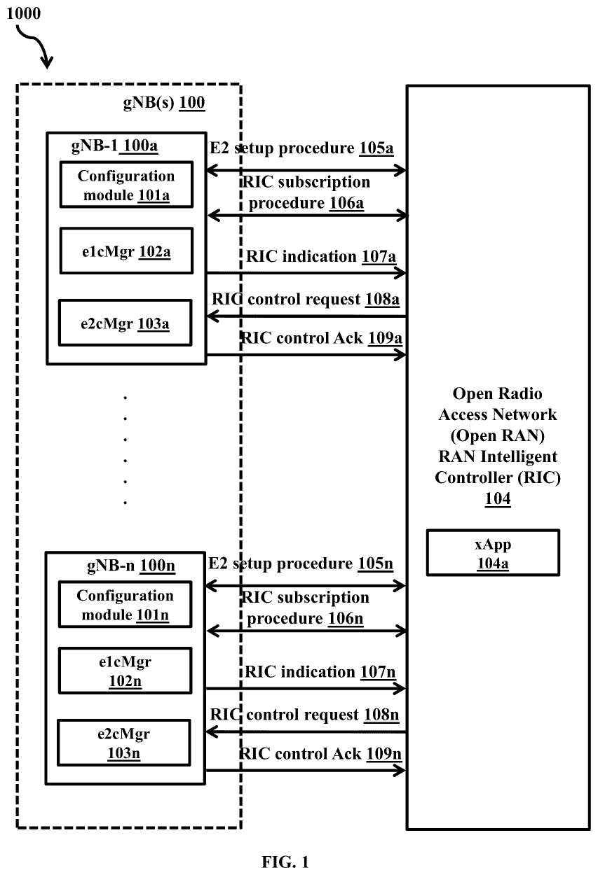

In one or more embodiments, an E1 Control Manager (e1cMgr) associated with the gNB is capable of executing the “Change of gNB-CU-UP” procedure to facilitate a transfer of UE(s) from the scale-in instance to alternative CU-UP instances, either within the same network element or across different network elements, contingent upon the load factors observed associated with the gNB(s). In scenarios where the CU-UP instances within the same network element are not experiencing overload or are unable to accommodate additional sessions, the e1cMgr can initiate the “Change of gNB-CU-UP” procedure utilizing the available instances based on current load conditions. Conversely, if the CU-UP instances managed by the e1cMgr are deemed sufficient to handle the existing load, it can establish an E1 connection with CU-UP instances from other network elements and proceed with the “Change of gNB-CU-UP” procedure, as described in conjunction with FIG. 1 to FIG. 6. In addition, to mitigate the risk of auto-scaling ping-pong effects, any CU-UP instance designated for the scale-in will be temporarily unavailable for session allocation for a configurable duration known as the auto session drain time (auto drain timer). This period allows for the potential influx of sessions, which may necessitate scaling out the CU-UP instance. The implementation of real-time ORAN-RIC can effectively prevent this ping-pong mechanism by ensuring more stable resource allocation and management

Referring now to the drawings, and more particularly to FIGS. 1 to 6, where similar reference characters denote corresponding features consistently throughout the figures, there are shown preferred embodiments.

FIG. 1 illustrates a block diagram of a system 1000 for initiating a change of Centralized Unit User Plane (CU-UP) procedure, according to an embodiment as disclosed herein.

In one or more embodiments, the system 1000 may include, for example, but is not limited to, a plurality of gNodeBs (gNBs) 100 (e.g., gNB-1 100a, . . . , gNB-n 100n) and an Open Radio Access Network (Open RAN) RAN Intelligent Controller (RIC) 104.

In one or more embodiments, each of the plurality of gNBs 100 may include a configuration module (Confd Maapi) (e.g., 101a, . . . , 101n), an E1 Connection Manager (e1cMgr) (e.g., 102a, . . . , 102n), and an E2 Connection Manager (e2cMgr) (e.g., 103a, . . . , 103n). The configuration module (e.g., 101a) is configured to manage a configuration of the gNB and provide an interface for the management of various parameters and settings that dictate the operation of the gNB (e.g., 100a). The configuration module (e.g., 101a) is further configured to handle a retrieval, storage, and modification of configuration data, ensuring that the gNB (e.g., 100a) operates according to one or more specified parameters. The configuration module (e.g., 101a) is further configured to utilize a Management Application Programming Interface (MAAPI) for interaction with one or more data models, allowing for dynamic updates and retrieval of configuration settings. It can send notifications to other modules when configuration changes occur, ensuring that all parts of the gNB (e.g., 101a) are synchronized with the latest settings.

In one or more embodiments, the e1cMgr (e.g., 102a) is configured to manage one or more E1 interface connections, which are critical for backhaul communication between the gNB (e.g., 100a) and the core network. The e1cMgr (e.g., 102a) is further configured to establish and maintain E1 connections to ensure reliable data transport, monitor one or more statuses of the one or more E1 interface connections, and perform maintenance tasks to ensure optimal performance. The e1cMgr (e.g., 102a) is further configured to detect faults in the one or more E1 interface connections and initiates recovery procedures as needed.

In one or more embodiments, the e2cMgr (e.g., 103a) is configured to manage one or more E2 interface connections, which is essential for communication between the gNB (e.g., 100a) and the O-RIC 104. The e2cMgr (e.g., 103a) is further configured to establish and maintain one or more E2 interface connections with the O-RIC 104 for control and management purposes, and process one or more messages received from the O-RIC 104 and send one or more responses or acknowledgments as necessary.

In one or more embodiments, the O-RIC 104 is configured to enhance the operational efficiency of RAN by providing intelligent control and optimization capabilities. It acts as a mediator between the gNB (e.g., 100a) and various RAN functions, enabling dynamic resource management and optimization. The O-RIC 104 may include an Xapp 104a and scale-in analytics engine (not shown in FIG. 1). The Xapp 104a is an application running on the O-RIC 104 that leverages data analytics to provide insights and optimizations for the RAN. The scale-in analytics engine is configured to analyze traffic patterns and network performance to make real-time decisions about resource allocation and network configuration.

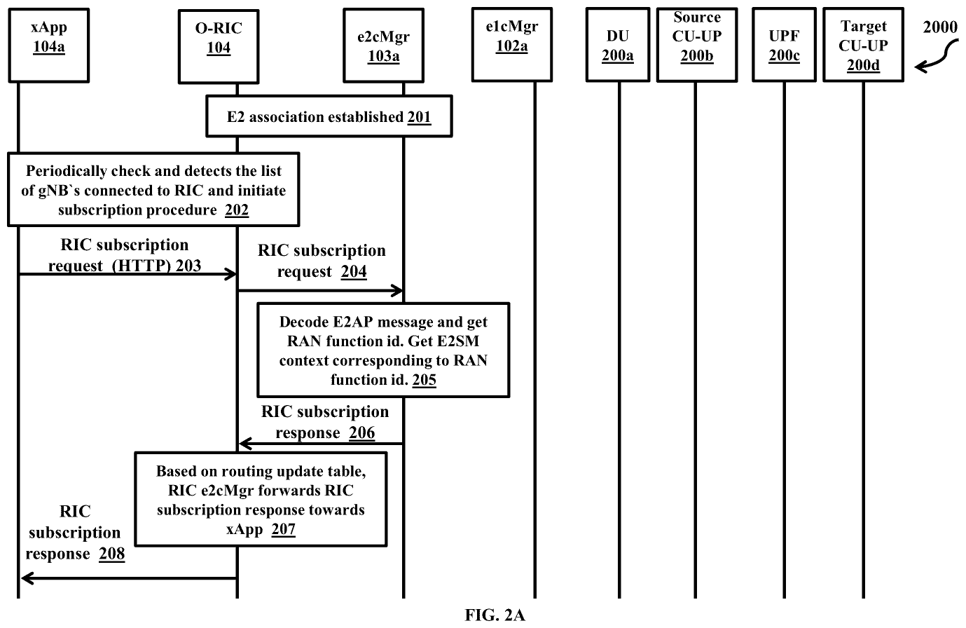

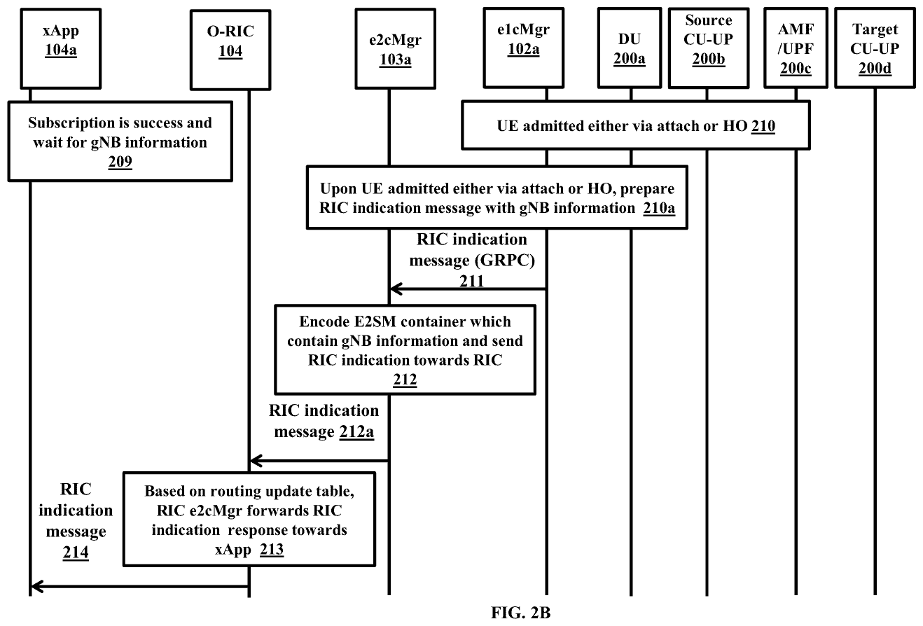

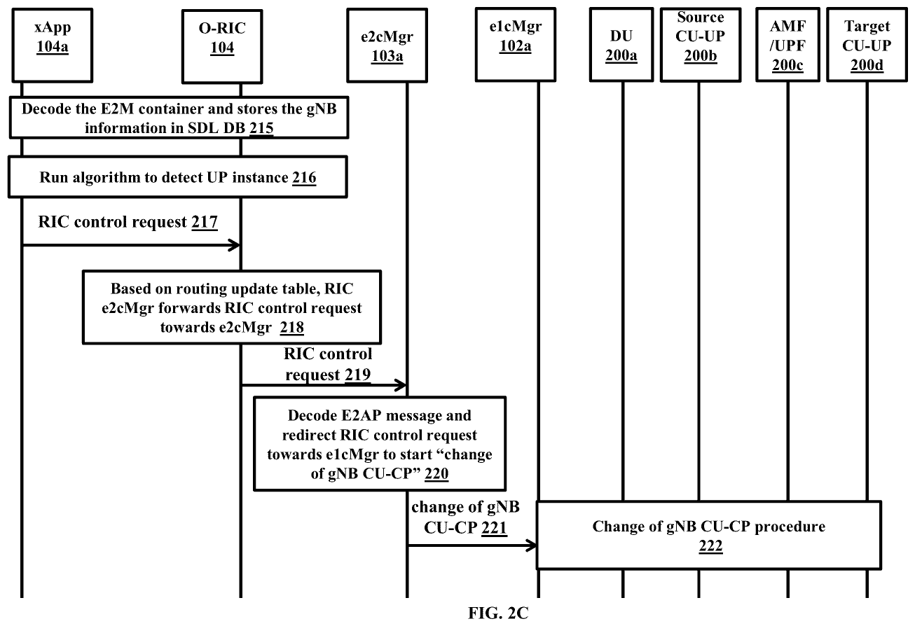

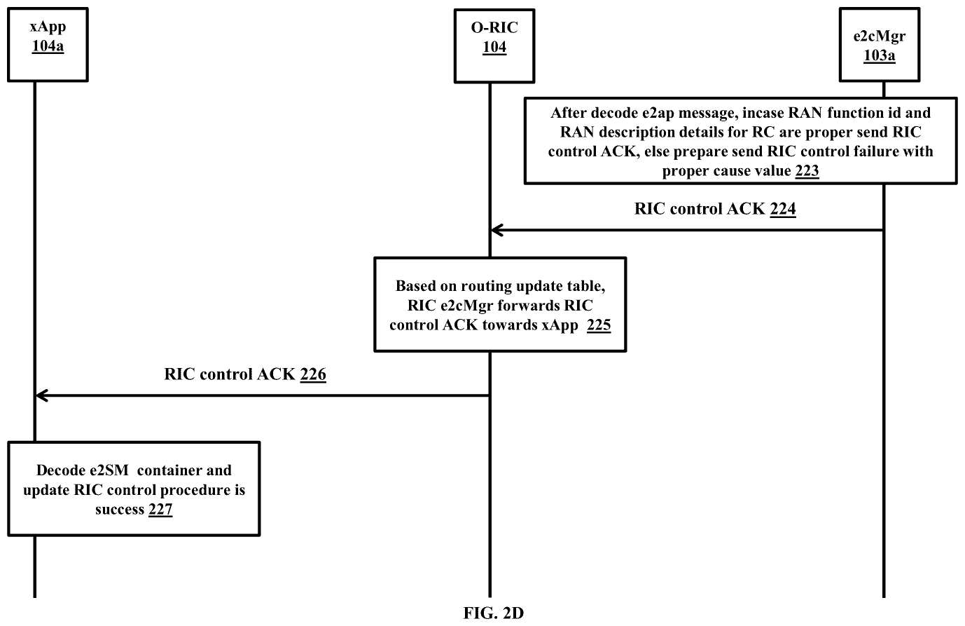

In one or more embodiments, the plurality of gNBs 100 is configured to interact with the O-RIC 104 through various signaling connections for UE offloading during CU-UP auto-scale down, as described in conjunction with FIG. 2A, FIG. 2B, FIG. 2C, and FIG. 2D. Examples of the various signaling connections may include an E2 setup procedure (e.g., 105a and 105n), an RIC subscription procedure (e.g., 106a and 106n), an RIC indication (e.g., 107a and 107n), an RIC control request (e.g., 108a and 108n), and an RIC control Ack (e.g., 109a and 109n).

The E2 setup procedure (e.g., 105a and 105n) establishes the one or more E2 interface connections between the gNB (e.g., 100a) and the O-RIC 104. The E2 setup procedure (e.g., 105a and 105n) involves the exchange of messages to set up the necessary parameters for communication, including establishing the one or more E2 interface connections and negotiating capabilities. The RIC subscription procedure (e.g., 106a and 106n) allows the gNB to subscribe to specific events or metrics that the RIC will monitor. For instance, the gNB (e.g., 100a) sends a subscription request to the O-RIC 104, specifying the parameters of interest. The O-RIC 104 acknowledges the subscription, and the gNB (e.g., 100a) starts receiving updates based on the subscribed events. The RIC indication (e.g., 107a and 107n) provides real-time data or alerts about network performance, allowing the gNB (e.g., 100a) to react accordingly. For instance, the O-RIC 104 sends indications to the gNB (e.g., 100a) based on one or more subscribed events or metrics. The RIC control request (e.g., 108a and 108n) includes requests for resource allocation, configuration changes, or other operational commands that the RIC can execute. For instance, the gNB (e.g., 100a) can send control requests to the O-RIC 104 for specific actions or adjustments. The RIC control Ack (e.g., 109a and 109n) acknowledges the receipt and processing of control requests sent by the gNB (e.g., 100a). For instance, the O-RIC 104 sends an acknowledgment back to the gNB (e.g., 100a), confirming that the requested action has been executed or providing the status of the request.

In one or more embodiments, the O-RIC 104 may execute multiple operations to initiate a change of CU-UP procedure by utilizing the various signaling connections, which are given below.

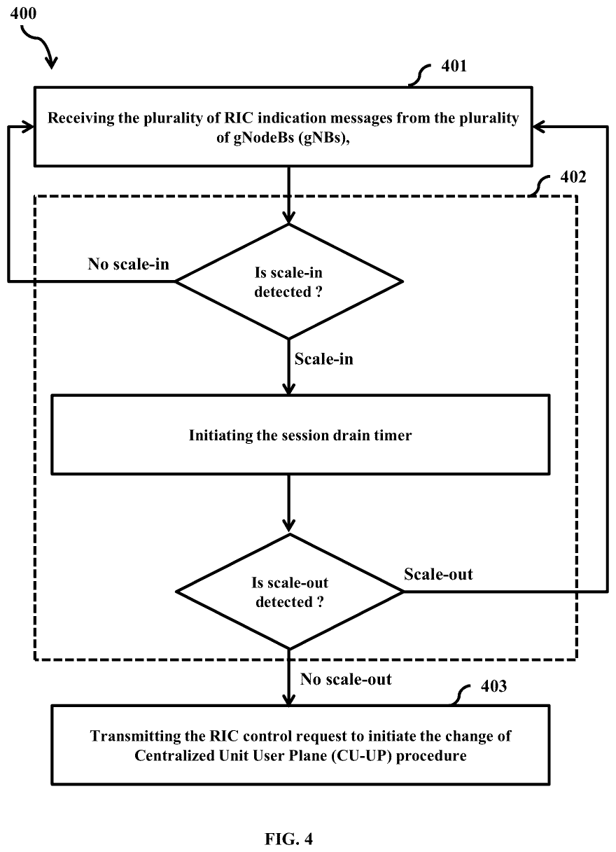

In one or more embodiments, the O-RIC 104 is configured to receive a plurality of RIC indication messages (i.e., RIC indication) (e.g., 107a and 107n) from the plurality of gNBs 100. Each of the plurality of RIC indication messages (e.g., 107a and 107n) comprises one or more network parameters. Examples of the one or more network parameters may include, but is not limited to, a value of load factor, a value of session drain timer, an identity of CU-UP instance, an Internet Protocol (IP) address of the CU UP e1cmgr, a throughput of the CU-UP instance, and a required UE context for change of CU-UP procedure upon UE admit on that UP instance. Upon receiving the plurality of RIC indication messages (e.g., 107a and 107n), the O-RIC 104 is further configured to determine whether a plurality network conditions satisfy one or more predefined criteria based on the one or more network parameters, as described in conjunction with FIG. 4. The plurality network conditions may include an identification of a scale-in, an expiration of a session drain timer, and an absence of any scale-out.

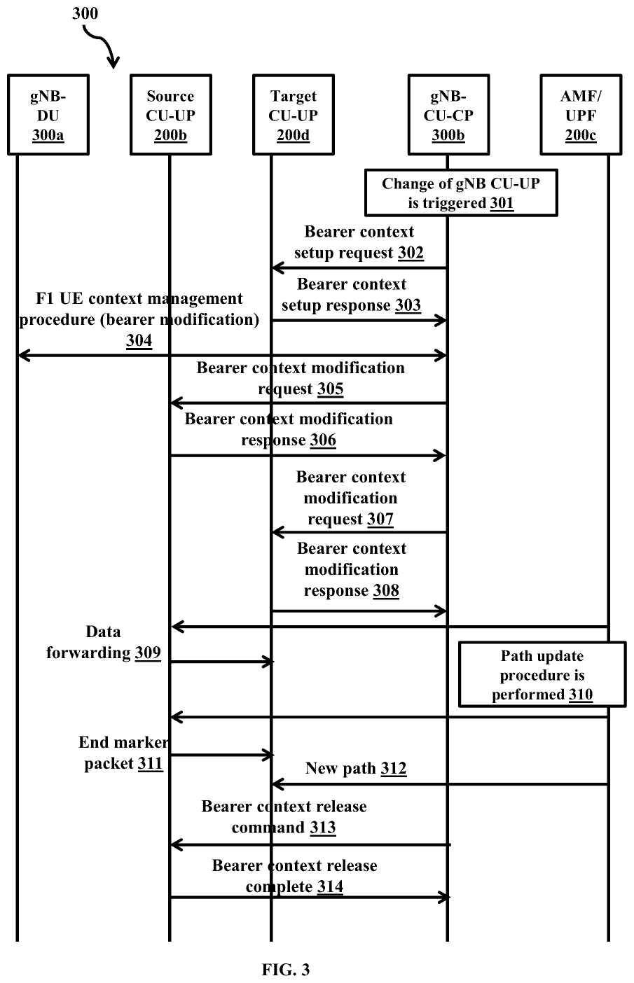

In one or more embodiments, the O-RIC 104 is further configured to transmit the RIC control request (e.g., 108a and 108n) in response to the plurality network conditions that satisfy one or more predefined criteria. The RIC control request (e.g., 108a and 108n) is transmitted to initiate a change of Centralized Unit User Plane (CU-UP) procedure for a set of User Equipments (UEs) associated with at least one gNB (e.g., 100a) among the plurality of gNBs 100. In other words, the O-RIC 104 is further configured to transmit the RIC control request (e.g., 108a and 108n) to a Centralized Unit Control Plane (CU-CP) associated with the at least one gNB for initialization of the change of CU-UP procedure, as described in conjunction with FIG. 3. The RIC control request (e.g., 108a and 108n) may include an instruction to transfer context information associated with the set of UEs from a source gNB-CU-UP to a target gNB-CU-UP. The instruction is triggered by an occurrence of the scale-in, the expiration of the session drain timer, and the absence of any scale-out at the source gNB-CU-UP associated with the at least one gNB. Examples of the context information may include, but are not limited to, a user Identity (ID), one or more Quality of Service (QoS) parameters, security information, session management information, session management information, mobility management information, and data path management information.

In one or more embodiments, the O-RIC 104 is further configured to transmit at least one recommendation message using the RIC control request (e.g., 108a and 108n) to the c1cMgr (e.g., 102a) of the gNB (e.g., 100a) experiencing scale-in conditions. This process is initiated when the e2cMgr (e.g., 103a) detects that the source gNB-CU-UP, managed by the e1cMgr (e.g., 102a), is becoming overloaded. The recommendation message aims to identify the target gNB-CU-UP, which may or may not have an Internet Protocol (IP) address, for a specified set of UEs. To facilitate this offloading, the recommendation message employs a MAAPI discovery procedure. This procedure establishes an E1 control session between the e1cMgr (e.g., 102a) of the selected gNB (e.g., 100a) and the source gNB-CU-UP. Consequently, this allows for the efficient transfer of the set of UEs to the identified target gNB-CU-UP, alleviating the overload on the source gNB-CU-UP.

In one or more embodiments, the O-RIC 104 is further configured to maintain a registry that is associated with the plurality of gNodeBs 100 with respective gNB-CU-UP information, enabling effective management and coordination of one or more UP resources across a network.

In one or more embodiments, the O-RIC 104 is further configured to receive an RIC control acknowledgement message (i.e., RIC control Ack) (e.g., 109a and 109n) from the at least one gNB (e.g., 100a) among the plurality of gNBs 100 upon transmitting the RIC control request (e.g., 108a and 108n).

FIGS. 2A-2D is a sequence flow diagram 2000 illustrating a plurality of operations associated with a plurality of network elements for UE offloading during CU-UP auto-scale down, according to an embodiment as disclosed herein. The plurality of network elements may include the xApp 104a, the O-RIC 104, the e2cMgr 103a, the e1cMgr 102a, a Distribution Unit (DU) 200a, a source CU-UP 200b, an Access and Mobility Management Function (AMF) and/or a User Plane Function (UPF) 200c, and a target CU-UP 200d. The plurality of network elements may execute the plurality of operations to initiate the change of CU-UP procedure by utilizing the various signaling connections, which are given below.

Referring to FIG. 2A: at operations 201-202, the e2cMgr 103a establishes an E2 association with the O-RIC 104. The O-RIC 104 periodically monitors and identifies the list of gNBs connected to it, subsequently initiating the subscription procedure for the xApp 104a. At operation 203, in this process, the xApp 104a transmits an HTTP-based RIC subscription request to the O-RIC 104. At operation 204, upon receipt of this request, the O-RIC 104 forwards the RIC subscription request to the e2cMgr 103a. At operations 205-206, the e2cMgr 103a decodes the E2AP message to extract the RAN Function ID and retrieves the corresponding E2SM context associated with that ID. Following this, the e2cMgr 103a sends a RIC subscription response back to the O-RIC 104. At operations 207-208, leveraging a routing update table, the O-RIC 104 forwards the RIC subscription response to the xApp 104a.

Referring to FIG. 2B: at operation 209, once the xApp 104a confirms the successful subscription, it awaits gNB information (e.g., one or more network parameters). At operations 210-210a, consider a scenario where a UE (not shown in FIG. 2B) is admitted via attach or handover (HO), the e1cMgr 102a prepares the RIC indication message (e.g., 107a and 107n) containing the relevant gNB information. At operation 211, the e1cMgr 102a then transmits this RIC indication message (e.g., 107a and 107n) using, for example, but is not limited to, gRPC or IPC mechanism, to the e2cMgr 103a. At operation 212, the e2cMgr 103a encodes the E2SM container with the gNB information and sends the RIC indication to the O-RIC 104. At operations 212a, 213, and 214, Subsequently, the e2cMgr 103a forwards the RIC indication message (e.g., 107a and 107n) to the O-RIC 104, which, based on its routing update table, directs the RIC indication response to the xApp 104a.

Referring to FIG. 2C: at operation 215, at the xApp 104a, the E2M container is decoded, and the gNB information is stored in the database (e.g., SDL, RNIB, etc.). At operations 216-217, the x O-RIC 104 then executes the disclosed method to detect the UP instance and transmits the RIC control request (e.g., 108a and 108n) to the O-RIC 104, which may relate to FIG. 4. At operations 218-219, the O-RIC 104, utilizing the routing update table, forwards the RIC control request (e.g., 108a and 108n) to the e2cMgr 103a. At operations 220, 221, and 222, upon receiving the request, the e2cMgr 103a decodes the E2AP message and redirects the RIC control request (e.g., 108a and 108n) to the e1cMgr 102a to initiate the “Change of gNB CU-CP” procedure by utilizing the DU 200a, the source CU-UP 200b, the AMF/UPF 200c, and the target CU-UP 200d, which may relate to FIG. 3.

Referring to FIG. 2D: at operations 223-224, after decoding the E2AP message, the e2cMgr 103a verifies the RAN Function ID and the RAN description details for the Resource Control (RC). If the parameters are valid, it sends an RIC Control Acknowledgment (ACK) (e.g., 109a and 109n); otherwise, it prepares to send an RIC control failure message with an appropriate cause value. At operations 225-226, the e2cMgr 103a transmits the RIC Control ACK (e.g., 109a and 109n) to the O-RIC 104, which, based on its routing update table, forwards the acknowledgment to the xApp 104a. At operation 227, upon receiving this, the xApp 104a decodes the E2SM container and updates its records to reflect the successful execution of the RIC control procedure.

FIG. 3 is a sequence flow diagram 300 illustrating a plurality of operations for initiating the change of CU-UP procedure, according to an embodiment as disclosed herein. The plurality of operations may be performed by the plurality of network elements a gNB-DU 300a, a gNB CU-CP 300b, the source CU-UP 200b, the AMF/UPF 200c, and the target CU-UP 200d.

At operation 301, the gNB CU-CP 300b receives the RIC control request (e.g., 108a and 108n) to initiate the change of CU-UP procedure via performing one or more procedures, as mentioned in operations 302 to 314. At operation 302, the gNB CU-CP 300b transmits a bearer context setup request to the target CU-UP 200d. At operation 303, the gNB CU-CP 300b receives a bearer context response from the target CU-UP 200d subsequent to the acknowledgment of the transmitted bearer context setup request. At operation 304, upon receiving the bearer context response, the gNB CU-CP 300b initiates an F1 UE context management procedure.

At operation 305, the gNB CU-CP 300b transmits a bearer context modification request to the source CU-UP 200b. At operation 306, the gNB CU-CP 300b receives a bearer context modification response from the source CU-UP 200b subsequent to the acknowledgment of the transmitted bearer context modification request. At operation 307, upon receiving the bearer context modification response, the gNB CU-CP 300b transmits a bearer context modification request to the target CU-UP 200d. At operation 308, the gNB CU-CP 300b receives a bearer context response from the target CU-UP 200d subsequent to the acknowledgment of the transmitted bearer context modification request. At operations 309-310, the AMF/UPF 200c initiates a path update procedure to transfer the context information associated with the set of UEs from the source gNB-CU-UP 200b to the target gNB-CU-UP 200d. At operations 311-312, the AMF/UPF 200c transmits an end marker packet to the source gNB-CU-UP 200b, the source gNB-CU-UP 200b forwards the end marker packet to the target gNB-CU-UP 200d to update a new path. At operation 313, the gNB CU-CP 300b transmits a bearer context release command to the source CU-UP 200b. At operation 314, the gNB CU-CP 300b receives a bearer context release complete from the source CU-UP 200b subsequent to the acknowledgment of the transmitted bearer context release command.

FIG. 4 is a flow diagram illustrating a method 400 for transmitting the RIC control request (e.g., 108a and 108n) to initiate the change of CU-UP procedure, according to an embodiment as disclosed herein. The method 400 may execute multiple operations to initiate the change of CU-UP procedure, which are given below.

At operation 401, the method 400 includes receiving the plurality of RIC indication messages (e.g., 107a and 107n) from the plurality of gNBs 100. Each of the plurality of RIC indication messages (e.g., 107a and 107n) includes the one or more network parameters.

At operation 402, the method 400 includes determining whether the scale-in occurs at the source gNB-CU-UP (e.g., 200b) based on the one or more network parameters. The method 400 includes continuously monitoring the plurality of RIC indication messages (e.g., 107a and 107n) in response to determining that the scale-in does not occur at the source gNB-CU-UP (e.g., 200b). The method 400 further includes initiating the session drain timer in response to determining that the scale-in occurs at the source gNB-CU-UP (e.g., 200b). The method 400 further includes determining, upon an expiration of the session drain timer, whether any scale-out absences at the source gNB-CU-UP (e.g., 200b) based on the one or more network parameters. The method 400 further includes continuously monitoring the plurality of RIC indication messages (e.g., 107a and 107n) in response to determining that any scale-out is present at the source gNB-CU-UP (e.g., 200b) after the expiration of the session drain timer.

At operation 403, the method 400 includes transmitting the RIC control request (e.g., 108a and 108n) to initiate the change of CU-UP procedure for the set of UEs associated with at least one gNB among the plurality of gNBs 100 in response to the plurality network conditions satisfy one or more predefined criteria, which may relate to operation 402. Further, a detailed description related to the various operations of FIG. 4 is covered in the description related to FIG. 1 to FIG. 3, and is omitted herein for the sake of brevity.

In one or more embodiments, the method 400 includes selecting, prior to transmitting the RIC control request (e.g., 108a and 108n), the set of UEs associated with the source gNB-CU-UP (e.g., 200b) in response to determining that any scale-out absences at the source gNB-CU-UP (e.g., 200b) based on the one or more network parameters.

In one or more embodiments, the method 400 includes selecting, prior to transmitting the RIC control request (e.g., 108a and 108n), one or more UEs associated with the source gNB-CU-UP (e.g., 200b) in response to determining that any scale-out absences at the source gNB-CU-UP (e.g., 200b) based on the one or more network parameters.

In one or more embodiments, in accordance with established standards, the gNodeB (e.g., 100a) initiates the E2C connection with the O-RIC 104. Each CU-UP Network Function (NF) is responsible for disseminating its associated New Radio (NR) User Plane instances to the O-RIC 104 via the E2C interface. This communication includes critical parameters such as the CU-UP instance identifier, IP address, session drain timer value, and relevant load factors, which may relate to the one or more network parameters. The O-RIC 104 maintains a comprehensive inventory of gNBs 100 along with their corresponding CU-UP details, facilitating efficient resource management. The c1cMgr (e.g., 102a) periodically transmits load factor metrics to the O-RIC 104 to enable real-time monitoring and decision-making.

By leveraging the disclosed method 400, the O-RIC 104 evaluates the load conditions and subsequently provides recommendations to the e1cMgr (e.g., 102a) regarding which CU-UP instance should be allocated for a specific set of UE when the currently serving CU-UP instances are nearing their capacity limits. If the e1cMgr (e.g., 102a) opts to redirect traffic to an alternative CU-UP instance, it communicates the necessary details, including the CU-UP instance identifier and its IP address. This triggers the Management API (MAAPI) discovery procedure, which is essential for establishing an ElC session, thereby allowing for the offloading of UEs to the designated CU-UP. In scenarios where the O-RIC 104 mechanism (method 400) identifies a CU-UP instance marked for the scale-in, and the session drain timer is actively running while new sessions are concurrently being established with other CU-UP instances, the O-RIC 104 will assess its predefined thresholds. Based on this assessment, it may either adjust the session drain timer or notify the e1cMgr (e.g., 102a) to temporarily mask the scale-in status of the CU-UP instance. This action ensures that session establishment requests can continue to be accepted, thereby maintaining service continuity and optimizing resource utilization.

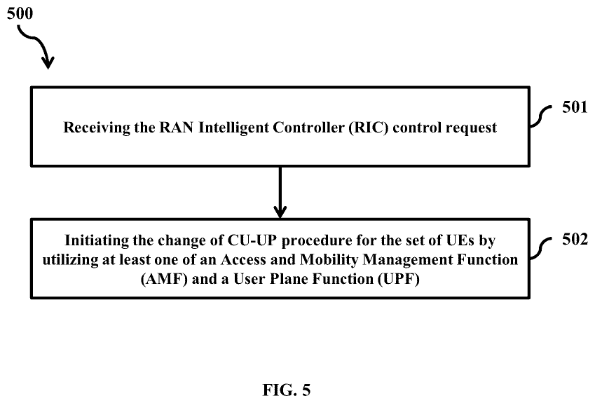

FIG. 5 is a flow diagram illustrating a method 500 for initiating the change of CU-UP procedure by utilizing the AMF and/or UPF, according to an embodiment as disclosed herein. The method 500 may execute multiple operations to initiate the change of CU-UP procedure, which are given below.

At operation 501, the method 500 includes receiving, at the CU-CP (e.g., 300b) associated with at least one gNB from the plurality of gNBs 100, the RIC control request (e.g., 108a and 108n). The RIC control request (e.g., 108a and 108n) may include the instruction to transfer context information associated with the set of UEs from the source gNB-CU-UP (e.g., 200b) to the target gNB-CU-UP (e.g., 200d). At operation 502, the method 500 includes initiating the change of CU-UP procedure for the set of UEs by utilizing at least one of the AMF and/or the UPF via performing the one or more procedures, which may relate to operations 222 and 301. Further, a detailed description related to the various operations of FIG. 4 is covered in the description related to FIG. 1 to FIG. 3, and is omitted herein for the sake of brevity.

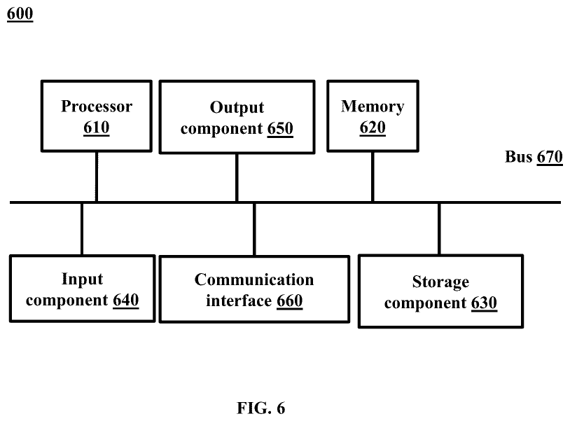

FIG. 6 illustrates a diagram of example components of an apparatus 600, according to an embodiment as disclosed herein. The apparatus 600 may associated with the O-RIC 104 or any other network entity. As shown in FIG. 6, the apparatus 600 comprises a processor 610, a memory 620, a storage component 630, an input component 640, an output component 650, a communication interface 660, and a bus 670.

The processor 610, as used herein, means any type of computational circuit that may comprise hardware elements and software elements. The processor 610 may be embodied as a multi-core processor, a single core processor, or a combination of one or more multi-core processors and/or one or more single core processors, a distributed processing apparatus, or the like. The processor 610 may be a Central Processing Unit (CPU), a graphics processing unit (GPU), an accelerated processing unit (APU), an application-specific integrated circuit (ASIC), or another type of processing component.

The memory 620 includes a non-transitory computer readable medium. Memory 620 includes a random-access memory (RAM), a read only memory (ROM), and/or another type of dynamic or static storage device (e.g., a flash memory, a magnetic memory, and/or an optical memory) that stores information and/or instructions for use by processor 610. The memory 620 comprises machine-readable instructions which are executable by the processor 610. These machine-readable instructions when executed by the processor 610 cause the processor 610 to perform one or more method steps of an embodiment described above.

The storage component 630 stores information and/or software related to the operation and use of the apparatus 600. For example, the storage component 630 may include a hard disk (e.g., a magnetic disk, an optical disk, a magneto-optic disk, and/or a solid-state disk), a Compact Disc (CD), a Digital Versatile Disc (DVD), a floppy disk, a cartridge, a magnetic tape, and/or another type of non-transitory computer-readable medium, along with a corresponding drive.

The input component 640 is configured to receive information, such as user input. For example, the input component 640 may include, but not be limited to, a touch screen display, a keyboard, a keypad, a mouse, a button, a switch, and/or a microphone. Additionally, or alternatively, the input component 640 may include a sensor for sensing information (e.g., a Global Positioning System (GPS), an accelerometer, a gyroscope, and/or an actuator).

The output component 650 is configured to provide output information from the apparatus 600. For example, the output component 650 may be, but is not limited to, a display, a speaker, instructions to an external device, and/or one or more Light-Emitting Diodes (LEDs).

The communication interface 660 is an interface that provides a communication connection to other devices, such as external devices and internal devices. The connection by the communication interface 660 can be a wired connection, a wireless connection, or a combination of wired and wireless connections, and can be a direct connection or an indirect connection via a communication network that exists between the apparatus 600 and other devices. In other words, the standard of the communication interface 660 is not limited.

The bus 670 acts as an interconnect between the processor 610, the memory 620, the storage component 630, the input component 640, the output component 650, and the communication interface 660 of the apparatus 600. The bus 670 may include a wired interconnection or a wireless interconnection.

The number and arrangement of components shown in FIG. 6 are provided as an example. In practice, the apparatus 600 may include additional components, fewer components, different components, or differently arranged components than those shown in FIG. 6. Additionally, or alternatively, a set of components (e.g., one or more components) of the apparatus 600 may perform one or more functions described as being performed by another set of components of the apparatus 600. Further, one or more method steps described in any of the embodiments may be performed utilizing the apparatus 600 in communication with one another.

The disclosed method/apparatus has several advantages over the existing mechanism, for example, which are stated below,
a. Cost efficiency: By reducing the number of active CU-UP instances during low traffic periods, the method contributes to lower operational costs and energy consumption, aligning with economic and environmental sustainability goals. For instance, during nighttime hours, user traffic drops significantly. The CU-UP instances automatically scale down, reducing operational costs associated with energy consumption and resource allocation, thereby maximizing profitability for the service provider.
b. Real-time decision-making: The periodic sharing of load factors and the RIC's proactive recommendations enable timely and informed decisions regarding resource allocation, ensuring optimal performance under varying conditions.
c. Enhanced user experience: By facilitating efficient offloading of UEs to less congested CU-UP instances after detecting the scale-in, the method ensures to maintain service quality and user experience, without initiating an abrupt UE release.
d. Reduced latency: By optimizing session establishments and offloading strategies, the method can contribute to lower latency in user data transmission, which is critical for applications requiring real-time responsiveness.
e. Intelligent traffic management: The integration of advanced mechanisms within the O-RIC 104 for traffic management enables more intelligent routing and resource allocation strategies, facilitating better overall network performance, after detecting the scale-in.

According to one embodiment of the present disclosure, a method is disclosed. The method includes receiving, at the O-RIC 104, the plurality of RIC indication messages (e.g., 107a and 107n) from the plurality of gNBs 100. Each of the plurality of RIC indication messages (e.g., 107a and 107n) comprises the one or more network parameters. The method further includes determining whether the plurality network conditions satisfy the one or more predefined criteria based on the one or more network parameters. The plurality network conditions comprise the identification of the scale-in, the expiration of the session drain timer, and the absence of any scale-out. The method further includes transmitting the RIC control request (e.g., 108a and 108n) in response to the plurality network conditions that satisfy one or more predefined criteria. The RIC control request (e.g., 108a and 108n) is transmitted to initiate the change of CU-UP procedure for the set of UEs associated with at least one gNB among the plurality of gNBs 100.

The method described in para [0067], the method includes transmitting the RIC control request (e.g., 108a and 108n) to the CU-CP associated with the at least one gNB for initialization of the change of CU-UP procedure. The RIC control request (e.g., 108a and 108n) comprises the instruction to transfer context information associated with the set of UEs from the source gNB-CU-UP (e.g., 200b) to the target gNB-CU-UP (e.g., 200d).

The method described in any one of paragraphs [0067]-[0068], the instruction is triggered by the occurrence of the scale-in, the expiration of the session drain timer, and the absence of any scale-out at the source gNB-CU-UP (e.g., 200b) associated with the at least one gNB.

The method described in any one of paragraphs [0067]-[0069], the method includes determining, upon receiving the plurality of RIC indication messages (e.g., 107a and 107n), whether the scale-in occurs at the source gNB-CU-UP (e.g., 200b) based on the one or more network parameters. The method further includes continuously monitoring the plurality of RIC indication messages (e.g., 107a and 107n) in response to determining that the scale-in does not occur at the source gNB-CU-UP (e.g., 200b). The method further includes initiating the session drain timer in response to determining that the scale-in occurs at the source gNB-CU-UP (e.g., 200b). The method further includes determining, upon the expiration of the session drain timer, whether any scale-out absences at the source gNB-CU-UP (e.g., 200b) based on the one or more network parameters. The method further includes continuously monitoring the plurality of RIC indication messages (e.g., 107a and 107n) in response to determining that any scale-out is present at the source gNB-CU-UP (e.g., 200b) after the expiration of the session drain timer. The method further includes selecting, prior to transmitting the RIC control request (e.g., 108a and 108n), the set of UEs associated with the source gNB-CU-UP (e.g., 200b) in response to determining that any scale-out absences at the source gNB-CU-UP (e.g., 200b) based on the one or more network parameters.

The method described in any one of paragraphs [0067]-[0070], the context information comprises at least one of the user Identity (ID), one or more Quality of Service (QoS) parameters, the security information, the session management information, the session management information, the mobility management information, and the data path management information.

The method described in any one of paragraphs [0067]-[0071], the method includes determining, based on the one or more network parameters, the target gNB-CU-UP (e.g., 200d) within the network element or the different network element (Network Function).

The method described in any one of paragraphs [0067]-[0072], the method includes transmitting at least one recommendation message using the RIC control request (e.g., 108a and 108n) to the e1cMgr of the at least one gNB for which the scale-in is detected via the e2cMgr to identify the target gNB-CU-UP (e.g., 200d) with or without an Internet Protocol (IP) address of other NF's UP instance (UP e1cmgr IP), when the source gNB-CU-UP (e.g., 200b) served by the e1cMgr become overloaded. The at least one recommendation message utilizes the Maapi discovery procedure, to establish the ele session between the e1cMgr of the at least one gNB and the source gNB-CU-UP (e.g., 200b), for offloading the set of UEs to the target gNB-CU-UP (e.g., 200d).

The method described in any one of paragraphs [0067]-[0073], the one or more network parameters comprise at least one of the value of load factor, the value of session drain timer, the identity of CU-UP instance, the Internet Protocol (IP) address of the CU UP e1cmgr, the throughput of the CU-UP instance, and the required UE context for change of CU-UP procedure upon UE admit on that UP instance.

The method described in any one of paragraphs [0067]-[0074], the method includes maintaining the registry that is associated with the plurality of gNodeBs 100 with respective gNB-CU-UP information, enabling effective management and coordination of one or more UP resources across the network.

The method described in any one of paragraphs [0067]-[0075], receiving, upon transmitting the RIC control request (e.g., 108a and 108n), the RIC control acknowledgement message (e.g., 109a and 109n) from the at least one gNB among the plurality of gNBs 100.

According to one embodiment of the present disclosure, a method is disclosed. The method includes receiving, at the CU-CP associated with at least one gNB from the plurality of gNBs (100), the RIC control request (e.g., 108a and 108n). The RIC control request (e.g., 108a and 108n) comprises the instruction to transfer context information associated with the set of UEs from the source gNB-CU-UP (e.g., 200b) to the target gNB-CU-UP (e.g., 200d). The method further includes initiating the change of CU-UP procedure upon receiving the RIC control request (e.g., 108a and 108n). The change of CU-UP procedure is initiated for the set of UEs associated with the at least one gNB by utilizing at least one of the AMF and the UPF via performing one or more procedures. The one or more procedures comprise at least one of the bearer context setup procedure, the F1 UE context management procedure, the bearer context modification procedure with the source gNB-CU-UP, the bearer context modification procedure with the target gNB-CU-UP, the context transformation, the path update procedure, and the bearer context release procedure.

According to one embodiment of the present disclosure, the apparatus 600 is disclosed. The apparatus 600 is configured to receive at the O-RIC 104, the plurality of RIC indication messages (e.g., 107a and 107n) from the plurality of gNBs 100. Each of the plurality of RIC indication messages (e.g., 107a and 107n) comprises the one or more network parameters. The apparatus 600 is further configured to determine whether the plurality network conditions satisfy one or more predefined criteria based on the one or more network parameters. The plurality network conditions comprise an identification of the scale-in, the expiration of the session drain timer, and the absence of any scale-out. The apparatus 600 is further configured to transmit the RIC control request (e.g., 108a and 108n) in response to the plurality network conditions that satisfy one or more predefined criteria. The RIC control request (e.g., 108a and 108n) is transmitted to initiate the change of CU-UP procedure for the set of UEs associated with at least one gNB among the plurality of gNBs 100.

According to one embodiment of the present disclosure, a non-transitory computer-readable medium storing instructions, the instructions comprising: one or more instructions that, when executed by the apparatus 600, the apparatus 600 comprising one or more processors. The one or more processors are configured to receive at the O-RIC 140, the plurality of RIC indication messages (e.g., 107a and 107n) from the plurality of gNBs 100. Each of the plurality of RIC indication messages (e.g., 107a and 107n) comprises one or more network parameters. The one or more processors are further configured to determine whether the plurality network conditions satisfy one or more predefined criteria based on the one or more network parameters. The plurality network conditions comprise an identification of the scale-in, the expiration of the session drain timer, and the absence of any scale-out. The one or more processors are further configured to transmit the RIC control request (e.g., 108a and 108n) in response to the plurality network conditions that satisfy one or more predefined criteria. The RIC control request (e.g., 108a and 108n) is transmitted to initiate the change of CU-UP procedure for the set of UEs associated with at least one gNB among the plurality of gNBs 100.

The embodiments disclosed herein can be implemented through at least one software program running on at least one hardware device and performing network management functions to control the elements. The elements can be at least one of a hardware device or a combination of hardware devices and software modules.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. A method comprising:
receiving, at an Open Radio Access Network (Open RAN) RAN Intelligent Controller (RIC), a plurality of RIC indication messages from a plurality of gNodeBs (gNBs), wherein each of the plurality of RIC indication messages comprises one or more network parameters;
determining, based on the one or more network parameters, whether a plurality of network conditions satisfy one or more predefined criteria,
wherein the plurality network conditions comprising an identification of a scale-in, an expiration of a session drain timer, and an absence of any scale-out; and
transmitting, in response to the plurality network conditions satisfy one or more predefined criteria, an RIC control request to initiate a change of Centralized Unit User Plane (CU-UP) procedure for a set of User Equipments (UEs) associated with at least one gNB among the plurality of gNBs.

2. The method according to claim 1, wherein transmitting the RIC control request to initiate the change of CU-UP procedure for the set of UEs associated with the at least one gNB comprises:
transmitting the RIC control request to a Centralized Unit Control Plane (CU-CP) associated with the at least one gNB for initialization of the change of CU-UP procedure,
wherein the RIC control request comprises an instruction to transfer context information associated with the set of UEs from a source gNB-CU-UP to a target gNB-CU-UP.

3. The method according to claim 2, wherein the instruction is triggered by an occurrence of the scale-in, the expiration of the session drain timer, and the absence of any scale-out at the source gNB-CU-UP associated with the at least one gNB.

4. The method according to claim 1, wherein determining whether the plurality network conditions satisfy one or more predefined criteria comprises:
determining, upon receiving the plurality of RIC indication messages, whether the scale-in occurs at a source gNB-CU-UP based on the one or more network parameters;
performing one of:
continuously monitoring the plurality of RIC indication messages in response to determining that the scale-in does not occur at the source gNB-CU-UP; or
initiating the session drain timer in response to determining that the scale-in occurs at the source gNB-CU-UP and determining, upon an expiration of the session drain timer, whether any scale-out absences at the source gNB-CU-UP based on the one or more network parameters;
performing one of:
continuously monitoring the plurality of RIC indication messages in response to determining that any scale-out is present at the source gNB-CU-UP after the expiration of the session drain timer; or
selecting, prior to transmitting the RIC control request, the set of UEs associated with the source gNB-CU-UP in response to determining that any scale-out absences at the source gNB-CU-UP based on the one or more network parameters.

5. The method according to claim 2, wherein the context information comprises at least one of a user Identity (ID), one or more Quality of Service (QoS) parameters, security information, session management information, session management information, mobility management information, and data path management information.

6. The method according to claim 2, comprising:
determining, based on the one or more network parameters, the target gNB-CU-UP within a network element or a different network element.

7. The method according to claim 1, wherein transmitting the RIC control request to initiate the change of CU-UP procedure for the set of UEs associated with the at least one gNB comprises comprising:
transmitting at least one recommendation message using the RIC control request to an E1 Control Manager (e1cMgr) of the at least one gNB for which the scale-in is detected via an E2 Control Manager (e2cMgr) to identify a target gNB-CU-UP with or without an Internet Protocol (IP) address of other NF's UP instance (UP e1cmgr IP), when the source gNB-CU-UP served by the e1cMgr become overloaded,
wherein the at least one recommendation message utilizes a Maapi discovery procedure, to establish an e1c session between the e1cMgr of the at least one gNB and the source gNB-CU-UP, for offloading the set of UEs to the target gNB-CU-UP.

8. The method according to claim 1, wherein the one or more network parameters comprise at least one of a value of load factor, a value of session drain timer, an identity of CU-UP instance, an Internet Protocol (IP) address of the CU UP e1cmgr, a throughput of the CU-UP instance, and a required UE context for change of CU-UP procedure upon UE admit on that UP instance.

9. The method according to claim 1, comprising:
maintaining a registry that is associated with the plurality of gNodeBs with respective gNB-CU-UP information, enabling effective management and coordination of one or more UP resources across a network.

10. The method according to claim 1, further comprising:
receiving, upon transmitting the RIC control request, a RIC control acknowledgement message from the at least one gNB among the plurality of gNBs.

11. A method comprising:
receiving, at a Centralized Unit Control Plane (CU-CP) associated with at least one gNodeB (gNB) from a plurality of gNodeBs (gNBs), a RAN Intelligent Controller (RIC) control request; and
initiating, upon receiving the RIC control request, a change of Centralized Unit User Plane (CU-UP) procedure for a set of User Equipments (UEs) associated with the at least one gNB by utilizing at least one of an Access and Mobility Management Function (AMF) and a User Plane Function (UPF) via performing one or more procedures,
wherein the RIC control request comprises an instruction to transfer context information associated with the set of UEs from a source gNB-CU-UP to a target gNB-CU-UP,
wherein the one or more procedures comprise at least one of a bearer context setup procedure, an F1 UE context management procedure, a bearer context modification procedure with the source gNB-CU-UP, a bearer context modification procedure with the target gNB-CU-UP, a context transformation, a path update procedure, and a bearer context release procedure.

12. An apparatus, the apparatus is configured to:
receive, at an Open Radio Access Network (Open RAN) RAN Intelligent Controller (RIC), a plurality of RIC indication messages from a plurality of gNodeBs (gNBs), wherein each of the plurality of RIC indication messages comprises one or more network parameters;
determine, based on the one or more network parameters, whether a plurality network conditions satisfy one or more predefined criteria,
wherein the plurality network conditions comprising an identification of a scale-in, an expiration of a session drain timer, and an absence of any scale-out; and
transmit, in response to the plurality network conditions satisfy one or more predefined criteria, an RIC control request to initiate a change of Centralized Unit User Plane (CU-UP) procedure for a set of User Equipments (UEs) associated with at least one gNB among the plurality of gNBs.

13. The apparatus according to claim 12, wherein to transmit the RIC control request to initiate the change of CU-UP procedure for the set of UEs associated with the at least one gNB, the apparatus is configured to:
transmitting the RIC control request to a Centralized Unit Control Plane (CU-CP) associated with the at least one gNB for initialization of the change of CU-UP procedure,
wherein the RIC control request comprises an instruction to transfer context information associated with the set of UEs from a source gNB-CU-UP to a target gNB-CU-UP.

14. The apparatus according to claim 13, wherein transformation of the context information is triggered by an occurrence of the scale-in, the expiration of the session drain timer, and the absence of any scale-out at the source gNB-CU-UP associated with the at least one gNB.

15. The apparatus according to claim 12, wherein to determine whether the plurality network conditions satisfy one or more predefined criteria, the apparatus is configured to:
determine, upon receiving the plurality of RIC indication messages, whether the scale-in occurs at a source gNB-CU-UP based on the one or more network parameters;
perform one of:
continuously monitoring the plurality of RIC indication messages in response to determining that the scale-in does not occur at the source gNB-CU-UP; or
initiating the session drain timer in response to determining that the scale-in occurs at the source gNB-CU-UP, and determining, upon an expiration of the session drain timer, whether any scale-out absences at the source gNB-CU-UP based on the one or more network parameters;
perform one of:
continuously monitoring the plurality of RIC indication messages in response to determining that any scale-out is present at the source gNB-CU-UP after the expiration of the session drain timer; or
selecting, prior to transmitting the RIC control request, the set of UEs associated with the source gNB-CU-UP in response to determining that any scale-out absences at the source gNB-CU-UP based on the one or more network parameters.

16. The apparatus according to claim 13, wherein the context information comprises at least one of a user Identity (ID), one or more Quality of Service (QoS) parameters, security information, session management information, session management information, mobility management information, and data path management information.

17. The apparatus according to claim 13, the apparatus is configured to:
determine, based on the one or more network parameters, the target gNB-CU-UP within a network element or a different network element.

18. The apparatus according to claim 12, wherein to transmit the RIC control request to initiate the change of CU-UP procedure for the set of UEs associated with the at least one gNB comprises, the apparatus is configured to:
transmit at least one recommendation message using the RIC control request to an E1 Control Manager (e1cMgr) of the at least one gNB for which the scale-in is detected via an E2 Control Manager (e2cMgr) to identify a target gNB-CU-UP with or without an Internet Protocol (IP) address of other NF's UP instance (UP e1cmgr IP), when the source gNB-CU-UP served by the e1cMgr become overloaded,
wherein the at least one recommendation message utilizes a Maapi discovery procedure, to establish an e1c session between the e1cMgr of the at least one gNB and the source gNB-CU-UP, for offloading the set of UEs to the target gNB-CU-UP.

19. The apparatus according to claim 12, wherein the one or more network parameters comprise at least one of a value of load factor, a value of session drain timer, an identity of CU-UP instance, an Internet Protocol (IP) address of the CU UP e1cmgr, a throughput of the CU-UP instance, and a required UE context for change of CU-UP procedure upon UE admit on that UP instance.

20. The apparatus according to claim 12, the apparatus is configured to:
maintain a registry that is associated with the plurality of gNodeBs with respective gNB-CU-UP information, enabling effective management and coordination of one or more UP resources across a network.
